(19) United States
(12) Patent Application Publication
(10) Pub. No.: US 2025/0108612 A1
(43) Pub. Date: Apr. 3, 2025

(54) DRIVE CIRCUIT, LIQUID DISCHARGE HEAD, LIQUID DISCHARGE DEVICE, LIQUID DISCHARGE APPARATUS, AND IMAGE FORMING APPARATUS

(71) Applicant: Arata Suzuki, KANAGAWA (JP)

(72) Inventor: Arata Suzuki, KANAGAWA (JP)

(73) Assignee: Ricoh Company, Ltd., Tokyo (JP)

(21) Appl. No.: 18/888,503

(22) Filed: Sep. 18, 2024

(30) Foreign Application Priority Data
Sep. 28, 2023 (JP) 2023-166796

(51) Int. Cl. B41J 2/045; B41J 2/14

(52) U.S. Cl. CPC B41J 2/04588; B41J 2/04581; B41J 2/14233

(57) ABSTRACT

A drive circuit includes a first drive-waveform generator circuit, first waveform-selection control circuits, second drive-waveform generator circuits, second waveform-selection control circuits, and memory circuits. The first drive-waveform generator circuit generates a first drive waveform applied to piezoelectric elements in a liquid discharge head. Each of the first waveform-selection control circuits is connected to the first drive-waveform generator circuits, to select the first drive waveform. The second drive-waveform generator circuits generates a second drive waveform applied to the piezoelectric elements corresponding to nozzles at each end of the liquid discharge head. The second waveform-selection control circuits are connected in parallel with the second drive-waveform generator circuits, respectively, to select one of the first drive waveform and the second drive waveform. The memory circuits is connected to the second drive-waveform generator circuits to store a correction voltage value of the second drive waveform.

### CROSS-REFERENCE TO RELATED APPLICATIONS

This patent application is based on and claims priority pursuant to 35 U.S.C. § 119(a) to Japanese Patent Application No. 2023-166796, filed on Sep. 28, 2023, in the Japan Patent Office, the entire disclosure of which is hereby incorporated by reference herein.

### BACKGROUND

### Technical Field

Embodiments of the present disclosure relate to a drive circuit, a liquid discharge head, a liquid discharge device, a liquid discharge apparatus, and an image forming apparatus.

### Related Art

In a liquid discharge head, discharge speed of droplets (liquid) is likely to change depending on positions at which nozzles are disposed. A technology is known that changes the drive voltage and the drive waveform of a liquid discharge head to reduce the change in the discharge speed.

### SUMMARY

In an embodiment of the present disclosure, a drive circuit includes a first drive-waveform generator circuit, first waveform-selection control circuits, second drive-waveform generator circuits, second waveform-selection control circuits, and memory circuits. The first drive-waveform generator circuit generates a first drive waveform to be applied to piezoelectric elements in a liquid discharge head. Each of the first waveform-selection control circuits is connected to the first drive-waveform generator circuit, to select the first drive waveform to be applied to corresponding one of the piezoelectric elements in the liquid discharge head. The second drive-waveform generator circuits generates a second drive waveform to be applied to the piezoelectric elements corresponding to nozzles disposed at each end of the liquid discharge head. The second waveform-selection control circuits are connected in parallel with the second drive-waveform generator circuits, respectively, to select one of the first drive waveform and the second drive waveform to be applied to the piezoelectric element corresponding to the nozzles disposed at each end of the liquid discharge head. The memory circuits are connected to the respective second drive- waveform generator circuits to store a correction voltage value of the second drive waveform to be applied to the piezoelectric element corresponding to the nozzles disposed at each end of the liquid discharge head.

In another embodiment of the present disclosure, a drive circuit includes a first drive-waveform generator circuit, first waveform-selection control circuits, and second waveform-selection control circuits. The first drive-waveform generator circuit generates a first drive waveform to be applied to piezoelectric elements in a liquid discharge head. Each of the first waveform-selection control circuits is connected to the first drive-waveform generator circuit to select the first drive waveform to be applied to the piezoelectric elements in the liquid discharge head. The second waveform-selection control circuits are respectively connected in parallel with the first drive-waveform generator circuits corresponding to nozzles disposed at each end of the liquid discharge head.

In still another embodiment of the present disclosure, a liquid discharge head includes the drive circuit, the nozzles, and the piezoelectric elements to be driven by the first drive waveform or the second drive waveform generated by the drive circuit to discharge the liquid from the nozzles.

In still another embodiment of the present disclosure, a liquid discharge head includes the drive circuit, the nozzles, and the piezoelectric elements to be driven by a drive waveform generated by the drive circuit to discharge the liquid from the nozzles.

In still another embodiment of the present disclosure, a liquid discharge device includes the liquid discharge head.

In still another embodiment of the present disclosure, a liquid discharge apparatus comprising the liquid discharge device.

In still another embodiment of the present disclosure, an image forming apparatus includes the liquid discharge apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a cross-sectional view of a recording head, taken along a longitudinal direction of a liquid chamber of the recording head, according to a first embodiment of the present disclosure;

FIG. 2 is a cross-sectional view of the recording head of FIG. 1, taken along a short-side direction of the liquid chamber of the recording head;

FIG. 3 is a diagram illustrating a head driver of a recording head according to the first embodiment of the present disclosure;

FIG. 4 is a schematic diagram illustrating an overall configuration of a mechanism of an image forming apparatus, according to the first embodiment;

FIG. 5 is a plan view of a relevant part of the mechanism of the image forming apparatus, according to the first embodiment;

FIG. 6 is a cross-sectional view of the image forming apparatus according to the first embodiment to illustrate another configuration of the image forming apparatus;

FIG. 7 is a top view of the image forming apparatus of FIG. 7, according to the first embodiment;

FIG. 8 is a diagram illustrating a configuration of a drive circuit to drive piezoelectric elements of a recording head included in the image forming apparatus according to the first embodiment;

FIG. 9A is a diagram illustrating dot positions corresponding to nozzle positions in an image forming apparatus, according to a comparative example;

FIG. 9B is a diagram illustrating dot positions corresponding to nozzle positions in an image forming apparatus, according to an embodiment of the present disclosure;

FIG. 10A is a diagram illustrating a correction processing of dot positions corresponding to nozzle positions by waveform voltage, performed by the image forming apparatus according to the first embodiment; FIG. 10B is a diagram illustrating a correction processing of dot positions corresponding to nozzle positions by waveform application, performed by the image forming apparatus according to the first embodiment; and FIG. 11 is a diagram illustrating a configuration of a drive circuit to drive piezoelectric elements of a recording head included in an image forming apparatus, according to a second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of embodiments of a drive circuit, a liquid discharge head, a liquid discharge device, a liquid discharge apparatus, and an image forming apparatus in detail with reference to the drawings.

### First Embodiment

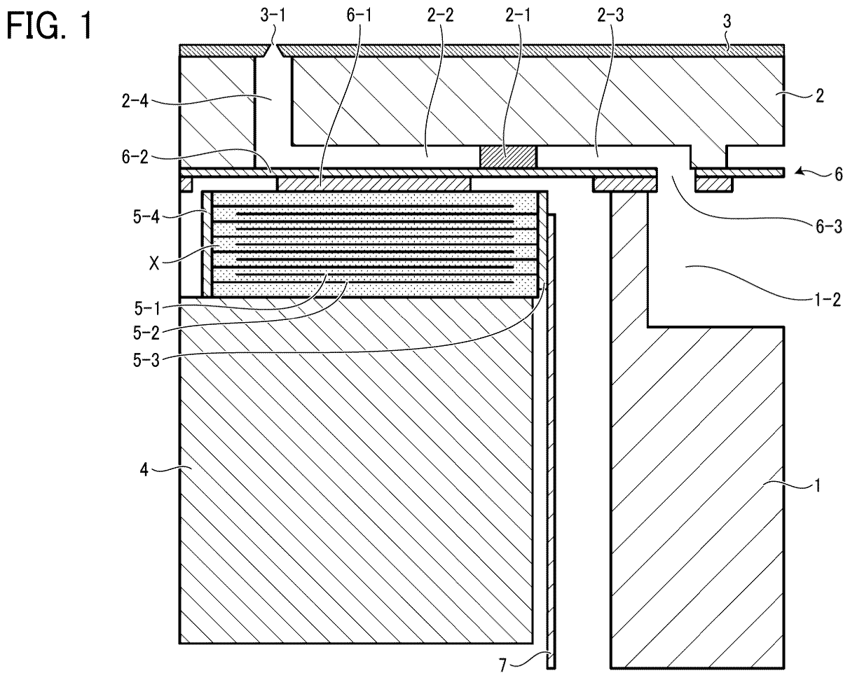

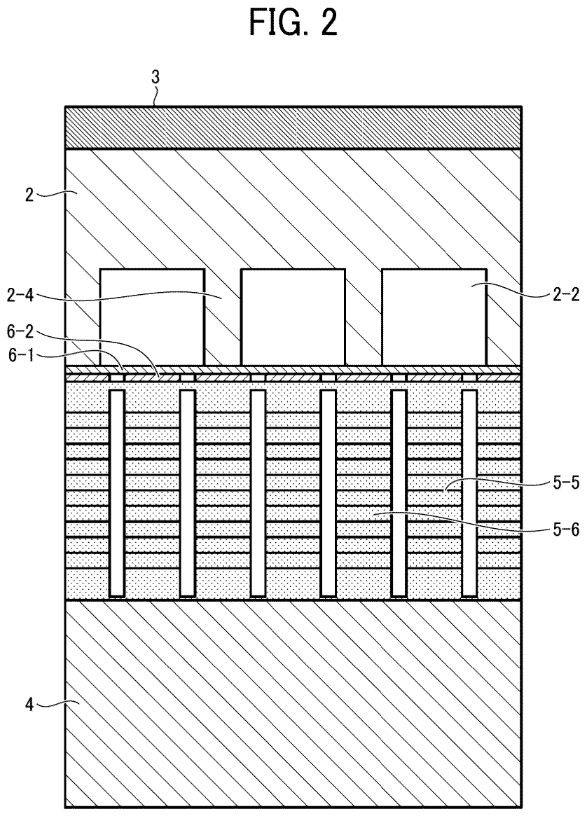

FIG. 1 is a cross-sectional view of a recording head, taken along a longitudinal direction of a liquid chamber of the recording head, according to a first embodiment of the present disclosure. FIG. 2 is a cross-sectional view of the recording head, taken along a short-side direction of the liquid chamber of the recording head.

The recording head, for example, an inkjet head, according to an embodiment of the present disclosure is an example of a liquid discharge head. The recording head includes, for example, a frame 1, a channel plate 2, a nozzle plate 3, a diaphragm 6, piezoelectric elements X, and a base 4. The frame 1 has a recess that serves as an ink supply port and a common liquid chamber 1-2. The channel plate 2 has a recess that serves as a fluid resistor 2-1 and a pressure-liquid chamber 2-2, and a communication port 2-3 communicating with a nozzle 3-1. The nozzle plate 3 includes the multiple nozzles 3-1. The diaphragm 6 has protruding portions 6-1, diaphragm portions 6-2, and an ink inlet 6-3. The piezoelectric elements X, for example, laminated piezoelectric elements, are bonded to the diaphragm 6 via a flexible printed circuit (FPC) 7. The base 4 fixes the piezoelectric elements X. The piezoelectric element X is an example of a piezoelectric element to which a drive waveform is applied to be driven to cause the nozzle 3-1 to discharge liquid.

The base 4 is made of barium-titanate ceramic, and two rows of the piezoelectric elements X are arranged and bonded to the base 4. Each of the piezoelectric elements X is formed by alternately stacking piezoelectric layers 5-1 of lead zirconate titanate (PZT), each having a thickness of 10 to 50 μm per layer and internal electrodes 5-2 made of silver palladium (AgPd), each having a thickness of several μm per layer. Each of the internal electrodes 5-2 is connected to an individual electrode 5-3 at both ends of the internal electrode 5-2.

The piezoelectric element X is divided into comb-teeth shape portions by half-cut dicing, and each of the comb-teeth shape portions is employed as a driver 5-5 or a supporting portion 5-6, i.e., a non-driving portion. The piezoelectric element X is formed by alternately stacking the piezoelectric layers 5-1 made of lead zirconate titanate (PZT) each having a thickness of 10 to 50 μm per layer and internal electrodes 5-2 made of silver palladium (AgPd) each having a thickness of several μm per layer. Each of the internal electrodes 5-2 is alternately and electrically connected to the individual electrode 5-3 and a common electrode 5-4 which is an end-surface electrode, i.e., an external electrode, of the piezoelectric element X.

The inkjet head according to the present embodiment employs the piezoelectric element X of a d33 mode, in which the piezoelectric layers 5-1 are displaced in a thickness direction of the piezoelectric element X. The piezoelectric element X contracts and expands to contract and expand the pressure-liquid chamber 2-2. The piezoelectric element X expands when a drive signal is applied to the piezoelectric element X to charge the piezoelectric element X. The piezoelectric element X contracts in a direction opposite the direction in which the piezoelectric element X expands when the charge that has been charged in the piezoelectric element X is discharged.

The FPC 7 is soldered to the individual electrodes 5-3 of the drivers 5-5. The common electrode 5-4 is connected to a ground electrode at the FPC 7 to which the piezoelectric elements X are bonded. A driver integrated circuit (IC) is mounted on the FPC 7, and the driver IC controls application of a drive voltage supplied to the drivers 5-5.

In the diaphragm 6, an opening that serves as the ink inlet 6-3 is formed by overlapping two layers of nickel (Ni) plating films by electroforming, an island-shaped protruding portion (an island portion) 6-1 and a thick-film portion including a beam joined to the supporting portions 5-6. The protruding portion 6-1 is joined to the piezoelectric element X that serves as the driver 5-5, which is formed at the center of the diaphragm portion 6-2.

The fluid resistor 2-1, the pressure-liquid chamber 2-2, and the communication port 2-3 are formed on the channel plate 2 by engraving a silicon single-crystal circuit board, and a through hole that serves as the communication port 2-3 at a position corresponding to the nozzle 3-1 is patterned by an etching method on the channel plate 2. A portion left by the etching is a partition wall 2-4 of the pressure-liquid chamber 2-2.

The nozzle plate 3 is formed of a metal material, for example, a nickel (Ni) plating film by electroforming, and has a large number of the nozzles 3-1 which are fine liquid discharge ports to discharge ink droplets. The cross section, i.e., the internal shape, of the nozzle 3-1 is a horn shape. The cross section of the nozzle 3-1 may be a substantially cylindrical shape or a substantially truncated cone shape.

The nozzle surface of the nozzle plate 3, through which ink is discharged, includes a water-repellent layer that is subjected to a water-repellent surface treatment. The water-repellent layer is formed by a treatment selected in accordance with the physical properties of ink from, for example, polytetrafluoroethylene (PTFE)-Ni eutectoid plating, electrodeposition of fluororesin, vapor deposition of explorative fluororesin (e.g., fluorinated pitch), firing after coating of a solution of silicon-based resin or fluorine-based resin. Accordingly, the water-repellent layer can stabilize the shape and flying properties of ink droplets and create high-quality images.

The frame 1 that is formed of resin molding, has a recess that serves as the ink supply port and the common liquid chamber 1-2.

In the above-described inkjet head, when a drive waveform of a pulse voltage of, for example, 10 to 50V is applied to the drivers 5-5 in accordance with a recording signal, the drivers 5-5 are displaced in a direction in which the drivers 5-5 are stacked, and the pressure-liquid chamber 2-2 is pressurized and the pressure in the pressure-liquid chamber 2-2 increases via the nozzle plate 3. Accordingly, ink droplets are discharged from the nozzle 3-1. Subsequently, as discharging of the ink droplets is completed, the ink pressure in the pressure-liquid chamber 2-2 is reduced, and a negative pressure is generated in the pressure-liquid chamber 2-2 by the inertia of the ink flow, and the discharge process of the driving pulse, which leads to an ink filling process. At this time, the ink that is supplied from an ink tank flows into the common liquid chamber 1-2. Then, the ink flows from the common liquid chamber 1-2 through the ink inlet 6-3, the communication port 2-3, and the fluid resistor 2-1 to be filled in the pressure-liquid chamber 2-2.

The fluid resistor 2-1 is effective in decreasing the residual pressure vibration after ink droplets are discharged. However, the fluid resistor 2-1 is a resistance when ink is refilled due to the surface tension of the ink. Appropriately selecting the resistance of the fluid resistor 2-1 allows the attenuation of the residual pressure and the refilling time of the ink to be balanced. Accordingly, the time (driving cycle) until next ink-droplets discharging operation is performed can be shortened.

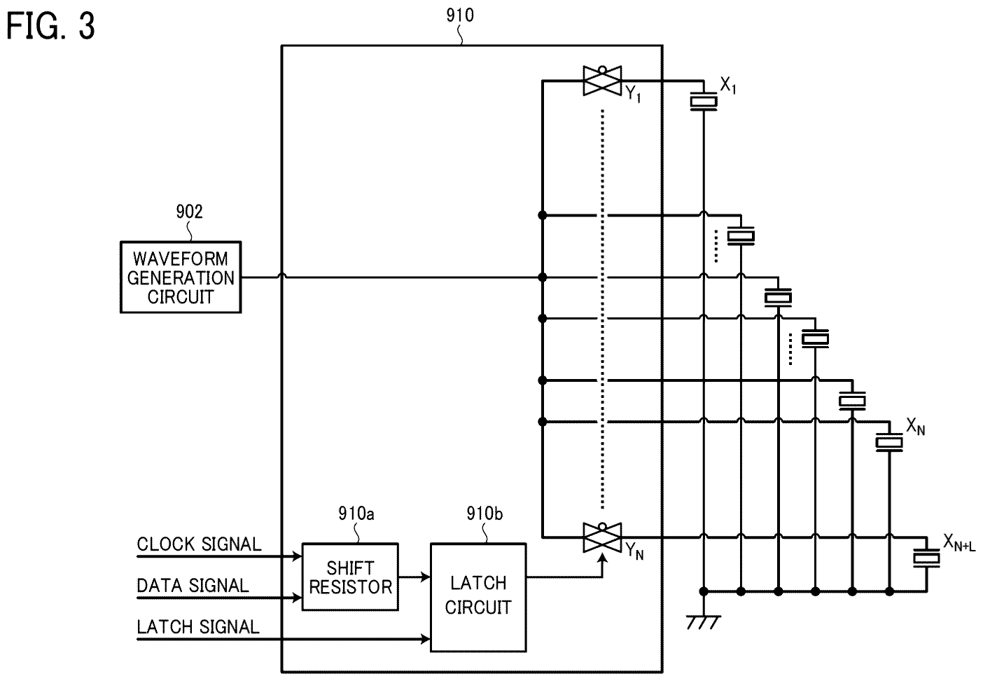

FIG. 3 is a diagram illustrating a head driver of a recording head according to the first embodiment of the present disclosure. The head driver of the inkjet head according to the first embodiment includes a drive-waveform generator circuit 902 as a first drive-waveform generator circuit and a drive circuit 910 as a head-module internal circuit. The drive-waveform generator circuit 902 generates and outputs a drive waveform including multiple drive pulses, i.e., drive signals, within one printing cycle at the time of image formation. The drive circuit 910 receives three-bit image data such as a gradation signa of 0, 1, or 2, corresponding to a print image, a clock signal, and a latch signal (LAT).

The drive circuit 910 includes a shift register 910a, a latch circuit 910b, and analog switches (ASWs) Y as second waveform-selection control circuits. The shift register 910a receives the image data and the waveform signal in response to a transfer clock signal (clock signal) from a data transfer device. The latch circuit 910b latches each register value (image data, waveform data) of the shift register 910a by a latch signal. Each of the ASWs Y selects a drive signal based on gradation data, i.e., image data and applies the drive signal to corresponding one of the piezoelectric elements X.

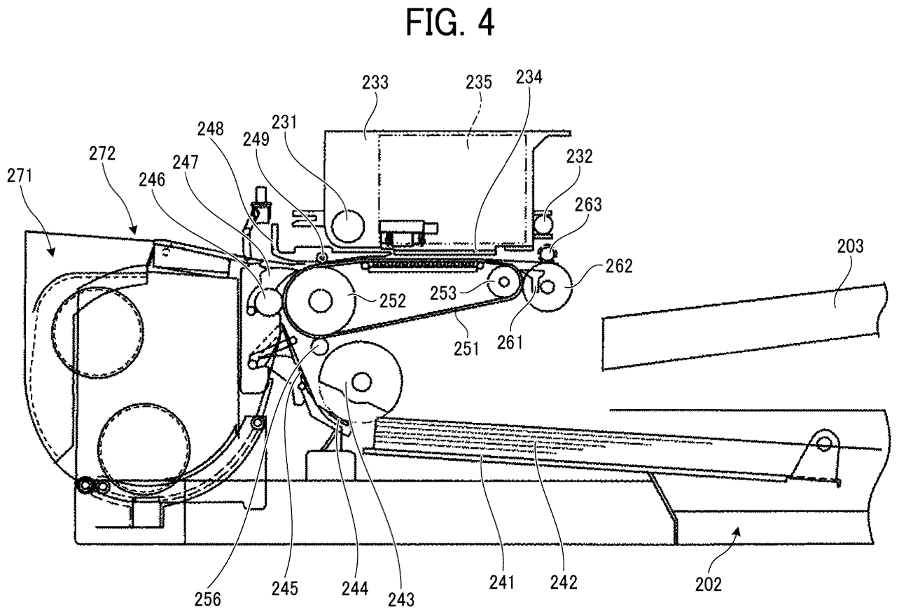

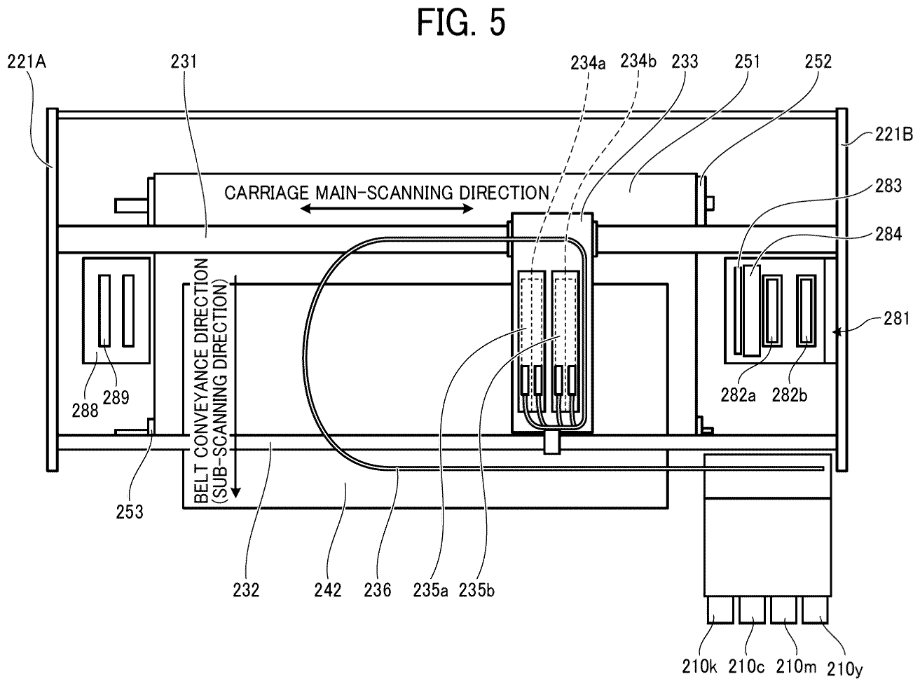

Next, a description is given below of a serial image forming apparatus including liquid discharge apparatus including the liquid discharge head, i.e., the inkjet head, according to an embodiment of the present disclosure with reference to FIGS. 4 and 5. FIG. 4 is a schematic diagram illustrating an overall configuration of a mechanism of the image forming apparatus according to the first embodiment. FIG. 5 is a plan view of a relevant part of the mechanism of the image forming apparatus according to the first embodiment.

The image forming apparatus according to the present embodiment is a serial-type image forming apparatus. The image forming apparatus includes a left-side plate 221A, a right-side plate 221B, a main guide rod 231, a sub guide rod 232, and a carriage 233. The carriage 233 is slidably held by the main guide rod 231 and the sub guide rod 232, which are guides bridged between the left-side plate 221A and the right-side plate 221B. The carriage 233 moves and scans in directions, i.e., carriage main-scanning directions, indicated by a double-headed arrow in FIG. 5 by a main scanning motor via a timing belt.

The carriage 233 includes recording heads 234a and 234b, which are collectively referred to as a recording head 234 unless distinguished. The recording heads 234a and 234b are examples of liquid discharge heads for discharging ink droplets, which are examples of liquid or droplets, of yellow (Y), cyan (C), magenta (M), and black (K). Each of the recording heads 234a and 234b includes a nozzle row including multiple nozzles arranged in a sub-scanning direction perpendicular to the carriage main-scanning direction.

The recording heads 234a and 234b each includes two nozzle rows. One nozzle row that includes the nozzles 3-1, of the recording head 234a discharges black (K) ink droplets, and the other nozzle row of the recording head 234a discharges cyan (C) ink droplets. One nozzle row of the recording head 234b discharges magenta (M) ink droplets, and the other nozzle row of the recording head 234b discharges yellow (Y) ink droplets. The carriage 233 includes head tanks 235a and 235b, which are collectively referred to as a head tank 235 unless distinguished, for supplying inks of colors corresponding to the nozzle rows of the recording head 234.

The head tank 235 is supplied with ink of the colors from ink cartridges 210k, 210c, 210m, and 210y of the respective colors via supply tubes 236 of the respective colors. The image forming apparatus includes a feeding roller 243, i.e., a sheet feeding roller, having a semicircular shape and a separation pad 244 made of a material having a large friction coefficient, which collectively serve as a sheet feeder. The feeding roller 243 having the semi-circular shape separates an uppermost sheet 242 from the sheets 242 stacked on a sheet stacker 241, i.e., a pressure plate, of a sheet feed tray 202, and feeds the sheets 242 one by one. The separation pad 244 is disposed facing the feeding roller 243 and biased toward the feeding roller 243.

The image forming apparatus includes a guide 245 to guide the sheet 242, a counter roller 246, a conveyance guide 247, and a pressing member 248 including a leading-end pressure roller 249 to feed a sheet 242 fed from the sheet feeder to a position below the recording head 234. The image forming apparatus also includes a conveyance belt 251 that serves as a sheet conveyor. The conveyance belt 251 electrostatically attracts the fed sheet 242 and conveys the sheet 242 to a position facing the recording head 234. The image forming apparatus further includes a charging roller 256 as a charger for charging the circumferential surface of the conveyance belt 251. The charging roller 256 is disposed to be in contact with the circumferential surface of the conveyance belt 251 and rotates by the rotation of the conveyance belt 251. The conveyance belt 251 rotates in the belt conveyance direction when the conveyance roller 252 is driven to rotate by a sub-scanning motor via a timing belt.

The image forming apparatus further includes a separation claw 261, a sheet ejection roller 262, a sheet ejection roller 263, and an output tray 203, which are collectively serve as a sheet ejector for ejecting the sheet 242 on which the recording head 234 has performed recording. The separation claw 261 separates the sheet 242 from the conveyance belt 251. The output tray 203 is disposed below the sheet ejection roller 262.

A duplex unit 271 is mounted on the rear side of the image forming apparatus in a detachable manner. The duplex unit 271 takes in the sheet 242 returned by the reverse rotation of the conveyance belt 251, reverses the sheet 242, and feeds the sheet 242 again between the counter roller 246 and the conveyance belt 251. The upper surface of the duplex unit 271 is a bypass feed tray 272.

The image forming apparatus further includes a maintenance device 281 for maintaining and recovering the condition of the nozzles of the recording head 234 in a non-printing area in one end of the carriage 233 in the scanning direction. The maintenance device 281 includes, for example, caps 282a and 282b, which may also be referred to simply as a cap 282 unless distinguished, for capping the nozzle surface of the recording head 234, a wiper blade 283 for wiping the nozzle surface, and a dummy discharge receiver 284. The dummy discharge receiver 284 receives ink droplets discharged during dummy discharge in which ink droplets that do not contribute to recording are discharged to discharge thickened recording liquid.

In a non-printing area on the other end of the carriage 233 in the scanning direction, a liquid collector 288 as a dummy discharge receiver is disposed to collect ink droplets discharged when dummy discharge is performed to discharge ink droplets that do not contribute to recording to discharge the thickened recording liquid. The liquid collector 288 has an opening 289 extending in a nozzle row direction of the recording head 234.

In the image forming apparatus as described above, the sheets 242 are separated and fed one by one from the sheet feed tray 202. The sheet 242 that is fed substantially vertically upward is guided by the guide 245, is conveyed while being sandwiched between the conveyance belt 251 and the counter roller 246. Subsequently, the sheet 242 that is guided by the conveyance guide 237 at the leading end of the sheet 242 is pressed against the conveyance belt 251 by the leading-end pressure roller 249, such that the conveyance direction of the sheet 242 is changed by about 90°.

At this time, positive power and negative power, i.e., alternating voltage, are alternately and repeatedly applied to the charging roller 256, and the conveyance belt 251 attains an alternating charged-voltage pattern. In other words, the conveyance belt 251 is alternately charged with positive and negative forming stripes with a predetermined width in the sub-scanning direction, which is the rotating direction of the conveyance belt 251. Once the sheet 242 is fed onto the conveyance belt 251 that is alternately charged with positive and negative voltages, the sheet 242 adheres to the conveyance belt 251, and the sheet 242 is conveyed in the sub-scanning direction by the rotational movement of the conveyance belt 251.

Then, the recording head 234 is driven according to the image signals while the carriage 233 is being moved. In so doing, ink droplets are discharged to the sheet 242 that is stopped to record a single line of the image. Then, the recording head 234 is driven according to the image signals while the carriage 233 is being moved. In so doing, ink droplets are discharged to the sheet 242 stopped to record a single line of the image. Then, the sheet 242 is conveyed by a predetermined amount, and the next line of the image is recorded.

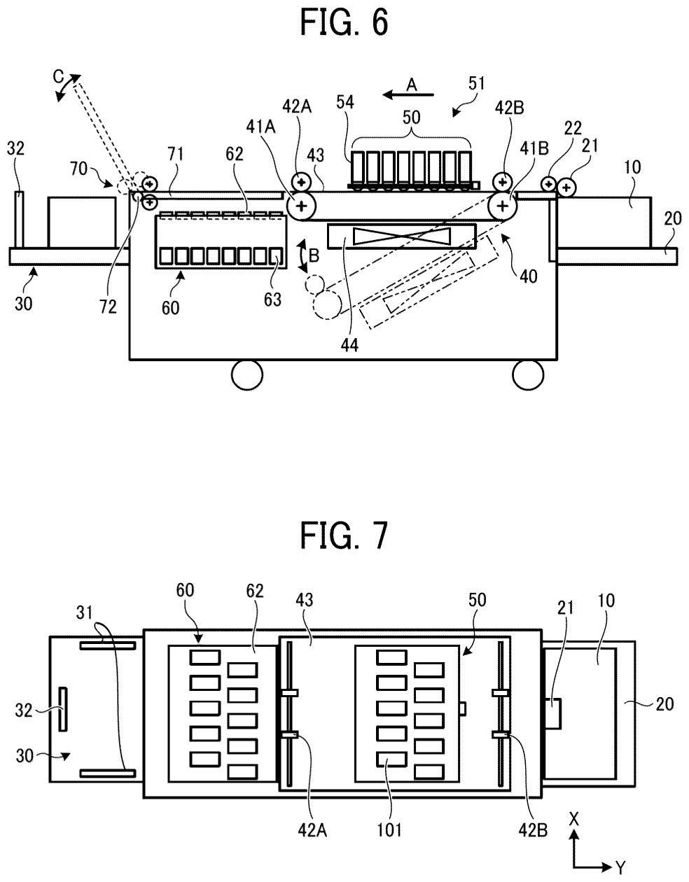

FIG. 6 is a cross-sectional view of the image forming apparatus according to the first embodiment to illustrate another configuration of the image forming apparatus.

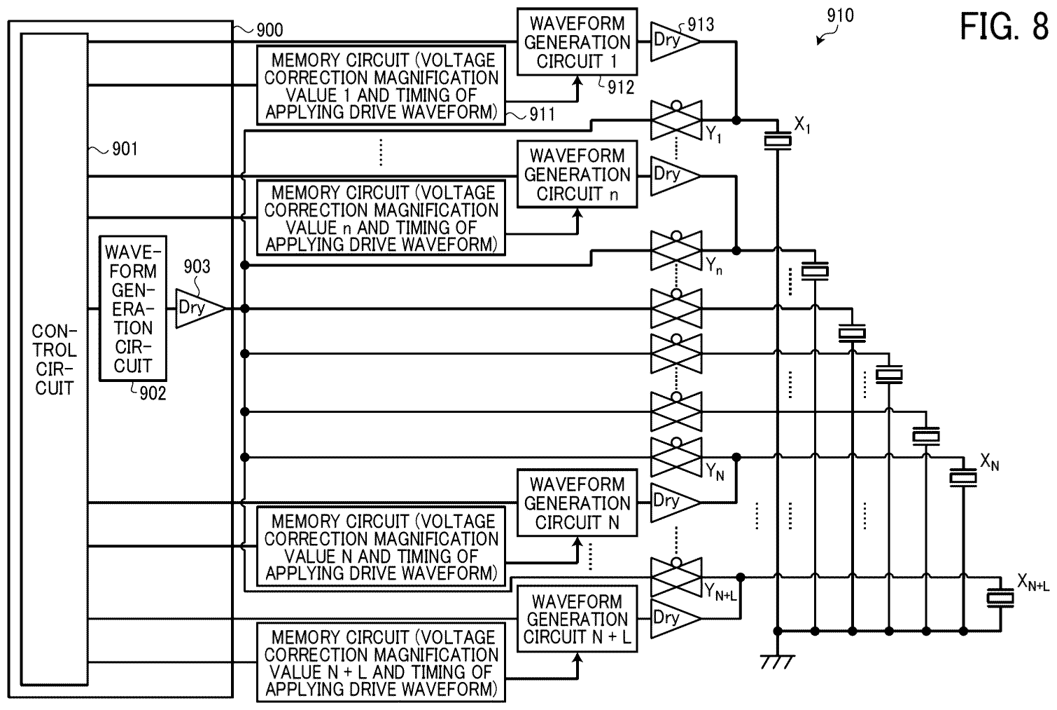

FIG. 7 is a top view of the image forming apparatus according to the first embodiment. As illustrated in FIGS. 6 and 7, the image forming apparatus of the present embodiment is a line-type image forming apparatus. The image forming apparatus includes a sheet tray 20, an output tray 30, a conveyor 40, an image forming device 51, a head cleaner 60, a conveyance guide 70, and an ink supply system. The sheet tray 20 feeds sheets 10 stacked on the sheet tray 20. The sheets 10 that are ejected are stacked on the output tray 30. The image forming device 51 includes a head-module array 50 including multiple recording heads 101 for discharging liquid droplets such as ink onto the sheet 10 conveyed by the conveyor 40. The head cleaner 60 serves as a maintenance device to maintain and recover discharge function of the multiple recording heads 101 of the head-module array 50 of the image forming device 51 after printing is finished or at a given timing. The conveyance guide 70 causes the head cleaner 60 to close and open. The ink supply system includes a sub tank and a main tank from which ink is supplied to the head-module array 50 of the image forming device 51. The sheet 10 as a recording medium is not limited to a sheet of paper, and a sheet made of another material such as an overhead projector (OHP) sheet may be employed.

The body of the image forming apparatus includes, for example, front and rear side plates, and a stay. The sheets 10 that are stacked on the sheet tray 20 are fed to the conveyor 40 one by one by a separation roller 21 and a sheet feeding roller 22. The conveyor 40 includes a conveyance-driving roller 41A, a conveyance-driven roller 41B, and an endless conveyance belt 43 wound around the conveyance-driving roller 41A and the conveyance-driven roller 41B. Multiple suction holes are formed on the surface of the conveyance belt 43, and a suction fan 44 that attracts the sheet 10 is disposed below the conveyance belt 43. A conveyance-guide roller 42A and a conveyance-guide roller 42B are held by guides and contact the conveyance belt 43 by their own weights, supported by the conveyance-guide rollers 42A and 42B from below, respectively.

As a motor drives the conveyance-driving roller 41A, the conveyance belt 43 moves in a circumferential direction, and the sheet 10 is attracted to the conveyance belt 43 by the suction fan 44 and conveyed by the circulation of the conveyance belt 43. The conveyance-driven roller 41B and the conveyance-guide rollers 42A and 42B are driven to rotate by the conveyance belt 43.

The image forming device 51 that includes the head-module array 50 to discharge liquid droplets to be printed on the sheet 10 is disposed above the conveyor 40 to be movable in a direction indicated by arrow A and in the opposite direction. The image forming device 51 moves to a position above the head cleaner 60 while a maintenance and recovery operation, i.e., cleaning, is performed and returns to the position illustrated in FIG. 6 while image formation is performed.

The image forming device 51 includes the head-module array 50 including the line-type recording heads 101 that discharge ink droplets of four colors of yellow (Y), magenta (M), cyan (C), and black (K) onto the sheet 10 that is conveyed while being attracted and held onto the conveyance belt 43. The head-module array 50 includes branching members 54 that distribute and supply ink to the recording heads 101. Each of the branching members 54 is integrated with corresponding one of the recording heads 101. The ink is supplied from the sub tank to the branching member 54. The ink is supplied from the main tank to the sub tank. The colors of ink that are employed in embodiments of the present disclosure are not limited to the above-described four colors. However, colors such as red, green, blue, and gray may be added to expand the range of colors or gradations to be reproduced.

The recording heads 101 are arranged such that one or more nozzles 3-1 at ends of two recording heads 101 adjacent to each other in a head arrangement direction, i.e., a direction indicated by arrow X in FIG. 7 and a direction orthogonal to a sheet conveyance direction, overlap each other. Accordingly, the nozzles 3-1 of the two recording heads 101 can perform recording at a substantially same recording position, i.e., a dot position. The nozzles 3-1 at the end of the recording head 101 that can print at a substantially same print position are referred to as overlapping nozzles 3-1. An area in which the overlapping nozzles 3-1 are positioned is referred to as a joint area, a nozzle-row overlapping area, a nozzle-overlapping area or portion, or an overlapping area.

The conveyance guide 70 that ejects the sheet 10 to the output tray 30 is disposed downstream from the conveyor 40 in the sheet conveyance direction. The sheet 10 that is guided and conveyed by the conveyance guide 70 is ejected to the output tray 30. The output tray 30 includes a pair of side fences 31 and an end fence 32. The pair of side fences 31 restricts the sheet 10 from shifting in the width direction of the sheet 10. The end fence 32 restricts the leading end of the sheet 10 from shifting in the sheet conveyance direction.

The head cleaner 60 is a maintenance device, and includes caps 62, wipers, and suction pumps 63. The caps 62 and the wipers correspond to the respective recording heads 101 of the image forming device 51. The suction pumps 63 suck ink from the respective nozzles 3-1 when the nozzle surfaces, on which the nozzles 3-1 are formed, of the recording heads 101 are capped by the respective caps 62.

In the image forming apparatus, after printing is finished, when ink is sucked from the nozzles 3-1 of the recording heads 101 or when ink adhering to the nozzle surfaces of the nozzles 3-1 of the recording heads 101 is cleaned by the wipers with the nozzle surfaces of the nozzle 3-1 being capped by the respective caps 62, the entire conveyor 40 rotates downward in a direction indicated by double-headed arrow B about the conveyance-driven roller 41B, as illustrated in FIG. 6. Accordingly, a space between the conveyor 40 and the image forming device 51 is larger than a space when image forming operation is performed. As a result, a space in which the image forming device 51 moves can be secured. At this time, a conveyance guide plate 71 of the conveyance guide 70 disposed above the head cleaner 60 also rotates upward in a direction indicated by double-headed arrow C about a fulcrum 72. Thus, an upper portion of the head cleaner 60 is opened.

After the conveyor 40 rotates downward and the conveyance guide 70 moves upward as described above, the image forming device 51 moves in the sheet conveyance direction, i.e., the direction indicated by arrow A, and stops at a position above the head cleaner 60. Then, for example, the caps 62 move upward to perform cleaning, i.e., the maintenance and recovery operation, of the recording heads 101.

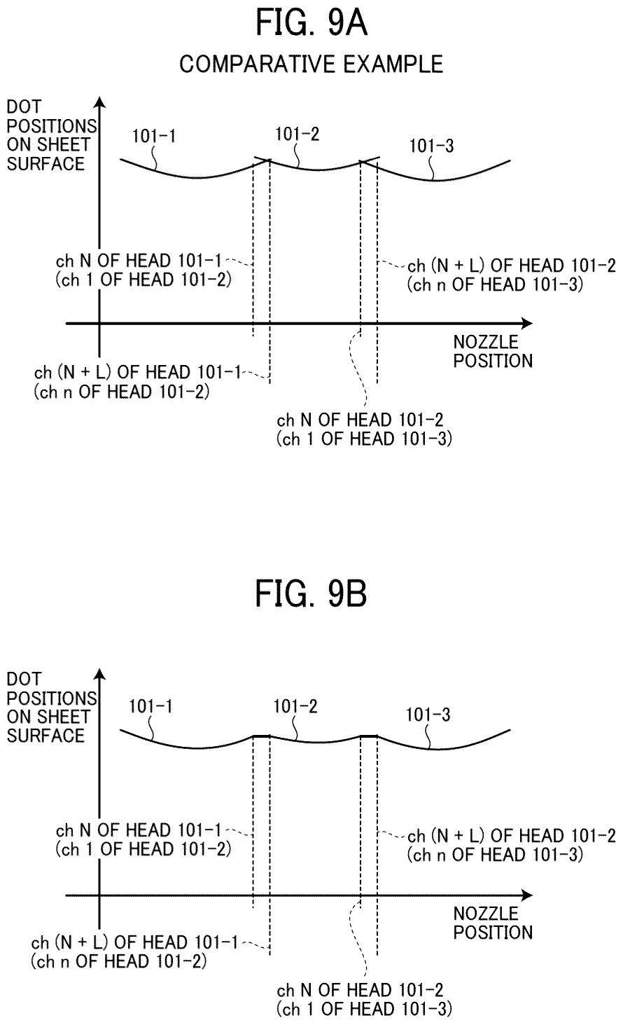

FIG. 8 is a diagram illustrating a configuration of a drive circuit of the piezoelectric elements X of the recording head 101 included in the image forming apparatus according to the first embodiment. In the present embodiment, the recording head 101 includes a host-device circuit 900 and the drive circuit 910 as drive circuits to drive N+L number of the piezoelectric elements X. A description is given below of the host-device circuit 900 and the drive circuit 910 of the recording head 101 illustrated in FIGS. 6 and 7. Drive circuits of the recording head 234 illustrated in FIGS. 4 and 5 have a similar configuration.

The host-device circuit 900 includes a control circuit 901, a drive-waveform generator circuit 902, and a driver (DRV) circuit 903. In the drive circuit 910, for example, memory circuits 911, drive-waveform generator circuits 912 as second drive-waveform generator circuits, DRV circuits 913 as second driver circuits, and the ASWs Y are mounted.

The ASW Y is an example of a waveform-selection control circuit that selects a drive waveform of the piezoelectric elements X of the nozzle 3-1 included in the recording head 101. In the present embodiment, each of the ASWs Y selects a drive waveform generated by the drive-waveform generator circuit 902 of the host-device circuit 900 or a drive waveform generated by corresponding one of the drive-waveform generator circuits 912 to be described below as a drive waveform to be applied to the corresponding one of piezoelectric elements X.

Each of the drive-waveform generator circuits 912 is mounted at a position of corresponding one of the piezoelectric elements X (X₁ to Xₙ, X_{N} to X_{N+L}) of the nozzles 3-1 disposed at ends of the recording head 101 in a longitudinal direction of the recording head 101 and connected to corresponding one of the ASWs Y (Y₁ to Yₙ, Y_{N} to Y_{N+L}) in parallel. The drive-waveform generator circuit 912 is an example of a drive-waveform generator circuit that generates a drive waveform.

Such a configuration as described above allows the drive circuit 910 that includes, for example, the memory circuits 911, the drive-waveform generator circuits 912, and the DRV circuits 913, of the respective piezoelectric elements X to be installed only in connecting portions in which the nozzles 3-1 of the recording head 101 are connected to each other. Accordingly, the size and the cost of the image forming apparatus can be prevented from increasing when the scale of the drive circuit 910 built into the recording head 101 is large.

The memory circuit 911 stores a voltage-correction scaled value, which is an example of a correction voltage value, of the waveform voltage of the drive waveform. In other words, the memory circuit 911 is disposed in parallel to the drive-waveform generator circuit 912. The memory circuit 911 is an example of a memory circuit that stores the voltage correction magnification value of the drive waveform generated by the drive-waveform generator circuit 912. In the present embodiment, the drive-waveform generator circuit 912 may generate a waveform obtained by correcting the drive waveform generated by the drive-waveform generator circuit 902 of the host-device circuit 900 as the drive waveform of the piezoelectric element X based on the voltage-correction scaled value stored in the memory circuit 911. For example, the drive-waveform generator circuit 912 may increase or decrease the discharge speed of liquid from the nozzle 3-1 by correcting the waveform voltage of the drive waveform generated by the drive-waveform generator circuit 902.

The host-device circuit 900 drives the piezoelectric elements X (X₁ to X_{N+L}) by the drive waveform generated by the drive-waveform generator circuit 902 and the DRV circuit 903. In the drive circuit 910, the drive-waveform generator circuits 912 and the DRV circuits 913 drive the respective piezoelectric elements X (X₁ to Xₙ and X_{N} to X_{N+L}) corresponding to both ends of the nozzles 3-1 of the recording head 101.

Accordingly, the drive circuit 910 can select whether the piezoelectric elements X (X₁ to Xₙ and X_{N} to X_{N+L}) corresponding to the piezoelectric elements X at both ends of the nozzles 3-1 are driven by the drive-waveform generator circuit 902 and the DRV circuit 903 of the host-device circuit 900 or by the respective drive-waveform generator circuits 912 and the respective DRV circuits 913 of the drive circuit 910.

The drive-waveform generator circuits 912 of the drive circuit 910 can correct the waveform voltage of the output waveform (drive waveform) and an application timing at which the drive waveform is applied to the piezoelectric elements X based on a setting of the respective memory circuits 911 storing the voltage correction value.

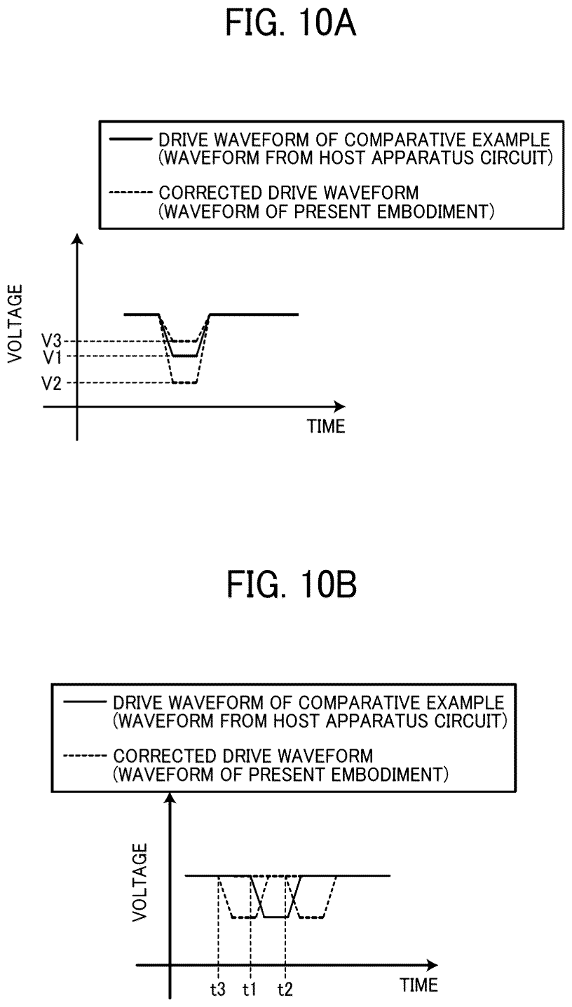

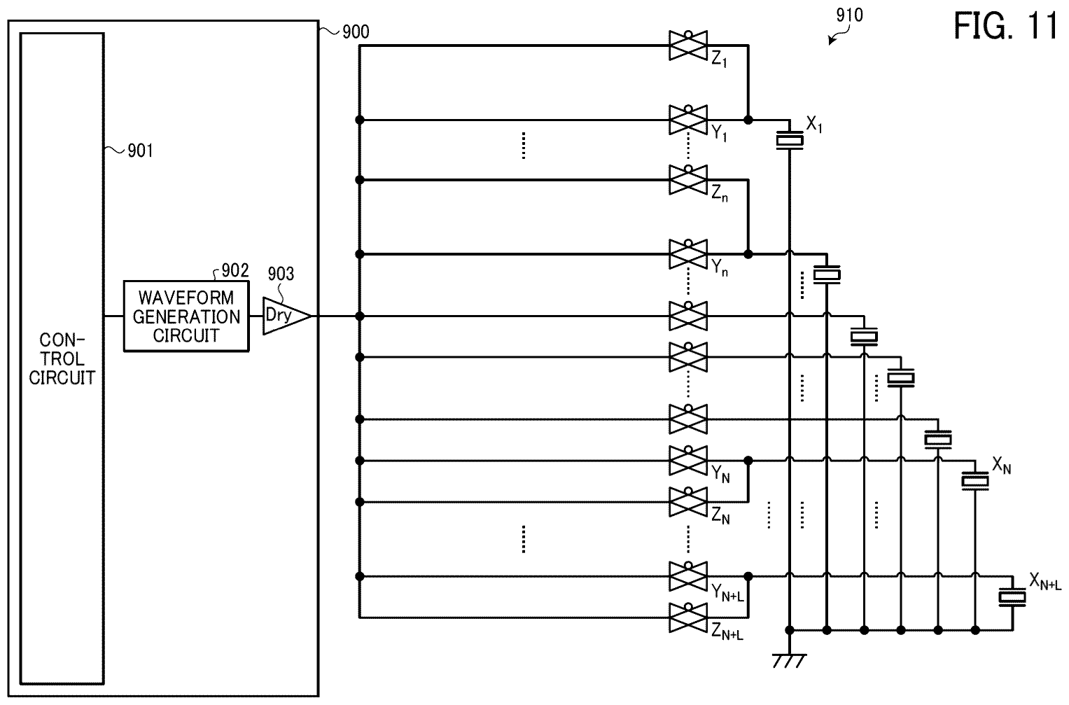

FIGS. 9A, 9B, 10A, and 10B are diagrams each illustrating a process of correcting dot positions corresponding to nozzle positions in the image forming apparatus according to the first embodiment. FIG. 9A is a diagram illustrating dot positions corresponding to nozzle positions of an image forming apparatus according to a comparative example. FIG. 9B is a diagram illustrating dot positions corresponding to nozzle positions of the image forming apparatus according to an embodiment of the present disclosure. In FIGS. 9A and 9B, the vertical axis represents dot positions on the sheet surface, and the horizontal axis represents the nozzle positions. In FIGS. 10A and 10B, the vertical axis represents the waveform voltage of the drive waveform for driving the piezoelectric elements X of the nozzles 3-1 of the recording head 101, and the horizontal axis represents time.

In the comparative example, due to manufacturing modifications of recording heads 101-1 to 101-3 (an example of the liquid discharge head), as illustrated in FIG. 9A, a difference in discharge speed depending on the nozzle positions may occur at a joint area between the recording head 101-1 and the recording head 101-2 and a joint area between the recording head 101-2 and the recording head 101-3.

In the example of FIG. 9A, the discharge speed of the recording head 101-1 increases from ch N (the piezoelectric element X_{N}) to ch N+L (the piezoelectric elements X_{N+L}), the discharge speed of the recording head 101-2 decreases from ch 1 (the piezoelectric element X₁) to ch n (the piezoelectric element Xₙ), the discharge speed of the recording head 101-2 increases from ch N (piezoelectric element X_{N}) to ch N+L (the piezoelectric element X_{N+L}), and the discharge speed of the recording head 101-3 decreases from ch 1 (the piezoelectric element X₁) to ch n (the piezoelectric element Xₙ). For this reason, FIG. 9A illustrates that the positional deviation of dots on the sheet surface occurs in the joint area between the recording head 101-1 and the recording head 101-2 and the joint area between the recording head 101-2 and the recording head 101-3.

As an example to correct the positional deviation of dots in the joint area between the recording head 101-1 and the recording head 101-2 and the joint area between the recording head 101-2 and the recording head 101-3, as illustrated in FIG. 8, the drive-waveform generator circuits 912 as individual drive circuits are mounted in the vicinity of both ends of the respective piezoelectric elements X₁ to Xₙ and X_{N} to X_{N+L}. As illustrated in FIG. 10A, the drive-waveform generator circuits 912 correct the waveform voltage of the drive waveform for driving the piezoelectric elements X of the recording head 101 from V1 to V2 to increase the discharge speed. By contrast, the drive-waveform generator circuits 912 correct the waveform voltage from V1 to V3 to decrease the discharge speed. By so doing, dots on the sheet surface in the joint area can be correctly positioned.

In FIG. 10B, the drive-waveform generator circuits 912 change the application timing at which the drive waveform is applied to the piezoelectric elements X of the recording head 101 from t1 to t2 to correct the landing positions of dots and increase the discharge speed. By contrast, the drive-waveform generator circuits 912 correct the drive waveform from t1 to t3 to decrease the discharge speed, such that the dot positions can be correctly positioned in the joint areas on the sheet surface. The correction voltage value or the correction timing value for each of the nozzles 3-1 can be set when image adjustment is performed on the image forming apparatus or when the image forming apparatus is shipped from the factory.

As described above, in the image forming apparatus of the first embodiment, for example, the memory circuits 911, the drive-waveform generator circuits 912, and the DRV circuits 913, included in the drive circuit 910, which drive the piezoelectric elements X, are mounted only in the nozzle-row overlapping area of the respective nozzles 3-1 included in the recording head 101. Accordingly, the size and the cost of the image forming apparatus can be prevented from increasing when the scale of the drive circuit built into the recording head 101 is large. In addition, the discharge speed or the discharge timing of liquid droplets such as ink droplets from the nozzles 3-1 of the recording head 101 can be changed. Further, the positional deviation of dots at the ends of the nozzle 3-1 can be reduced.

### Second Embodiment

The image forming apparatus according to a second embodiment of the present disclosure includes first-waveform selection control circuits and second waveform selection control circuits. Each of the first-waveform selection control circuits selects a drive waveform of a piezoelectric element of a nozzle included in a liquid discharge head. Each of the second waveform selection control circuits is mounted at a position of the corresponding one of the piezoelectric elements of the nozzle at both ends of the liquid discharge head and is disposed in parallel with corresponding one of the first-waveform selection control circuits. In the following description, description of a configuration similar to the configuration of the first embodiment is omitted.

FIG. 11 is a diagram illustrating a configuration of the drive circuit 910 that drives the piezoelectric elements X of the recording head 101 included in the image forming apparatus, according to the second embodiment.

In the present embodiment, the recording head 101 includes the host-device circuit 900 and the drive circuit 910 as a head-Md internal circuit to drive N+L number of the piezoelectric elements X. The host-device circuit 900 includes the control circuit 901, the drive-waveform generator circuit 902, and the DRV circuit 903. The ASWs Y (Y₁ to Y_{N+L}) and ASWs Z (Z₁ to Z_{N}, Z_{N} to Z_{N+L}) are mounted and connected to the respective piezoelectric elements X (X₁ to X_{N}, X_{N} to X_{N+L}) in parallel. The ASWs Y are examples of the first-waveform selection control circuits. Each of the ASWs Y selects a drive waveform of the piezoelectric element X of the nozzle 3-1 included in the recording head 101. The ASWs Z are mounted at the positions of the respective piezoelectric elements X (X₁ to Xₙ and X_{N} to X_{N+L}) of the nozzle 3-1 at both ends of the recording head 101 in the longitudinal direction of the recording head 101 and connected to the respective ASWs Y in parallel. The ASWs Z are examples of the second-waveform selection control circuits. Thus, an on-resistance, which is the total resistance between the drain and source terminals during operation, of the ASWs Y and the ASWs Z can be changed by a timing at which each of the ASWs Y and corresponding one of the ASWs Z are switched between each other to adjust the voltage, i.e., the waveform voltage, applied to corresponding one of the piezoelectric elements X

As described above, in the image forming apparatus of the second embodiment, the drive circuits, such as the ASWs Z, that drive the piezoelectric elements X are mounted only in the nozzle-row overlapping area of the nozzles 3-1 included in the recording head 101. Accordingly, the size and the cost of the image forming apparatus can be prevented from increasing when the scale of the drive circuit built into the recording head 101 is large.

In the embodiments as described above, the image forming apparatus is applied to a multifunction printer or multifunction peripheral (MFP) that has at least two of a photocopying function, a printing function, a scanning function, and a facsimile (FAX) function. However, no limitation is indicated thereby, and the image forming apparatus may be applied to any image forming apparatus such as a copier, a printer, a scanner, and a facsimile (FAX).

In embodiments of the present disclosure, the pressure generator used in the liquid discharge head (the recording head 234, the recording head 101) is not limited to a particular type of pressure generator. The pressure generator is not limited to the piezoelectric actuator (or a laminated-type piezoelectric element) described in the above-described embodiments, and may be, for example, a thermal actuator that employs a thermoelectric transducer element, such as a thermal resistor, or an electrostatic actuator including a diaphragm and opposed electrodes.

The terms “image formation”, “recording”, “printing”, “image printing”, and “fabricating” used herein may be used synonymously with each other.

The liquid discharge device is an assembly of parts relating to liquid discharge. The term liquid discharge device represents a structure including the head and a functional part(s) or mechanism combined to the head to form a single unit. For example, the liquid discharge device includes a combination of the head with at least one of a head tank, a carriage, a supply unit, a maintenance unit, and a main scan moving unit to form a single unit.

In the above-embodiments of the present disclosure, the terms “combined” or “integrated” mean attaching the liquid discharge head and the functional parts or the supply mechanism, the performance maintenance and recovery mechanism, the main scanning movement mechanism to each other by fastening, screwing, binding, or engaging and holding one of the liquid discharge head and the functional parts to the other movably relative to the other. Further, liquid discharge head, a functional component(s), and a mechanism(s) may also be detachably attached to one another.

For example, a head and a head tank may form a liquid discharge device as a single unit. Alternatively, the head and the head tank such as the head tank 235, coupled (connected) with, for example, a tube may form the liquid discharge device as a single unit. In the present embodiment, a unit including a filter may further be added to a portion between the head tank and the liquid discharge head.

In another example, a liquid discharge head and a carriage such as the carriage 233, may form a liquid discharge device as a single unit.

In still another example, the liquid discharge device may include the liquid discharge head movably held by a guide that forms a part of a main-scanning movement device, so that the liquid discharge head and the main-scanning movement device are integrated as a single unit. In still another example, a liquid discharge device may include a head, a carriage, and a main scan movement unit that form a single unit.

In still another example, a cap such as the cap 282, that forms a part of the maintenance device such as the maintenance device 281, may be secured to the carriage mounting the head so that the head, the carriage, and the maintenance unit form a single unit to form the liquid discharge device.

Further, in still another example, the liquid discharge device includes tubes such as the supply tube 236, connected to the head tank or the head mounting a channel member so that the head and the supply unit form a single unit. Through the tubes, liquid of a liquid storage source is supplied to the liquid discharge head.

The main-scanning movement mechanism may be a guide only. The supply unit may be a tube(s) only or a loading unit only.

In the above-described embodiments, the liquid discharge apparatus that discharges liquid includes the head or the liquid discharge device and drives the head to discharge a liquid. Examples of the liquid discharge apparatus include an apparatus capable of discharging liquid to a material to which liquid can adhere and an apparatus to discharge liquid toward gas or into liquid.

The liquid discharge apparatus can include at least one of devices for feeding, conveying, and ejecting a material onto which liquid can adhere. The liquid discharge apparatus can further include at least one of a pretreatment apparatus and a post-treatment apparatus.

The liquid discharge apparatus may be, for example, an image forming apparatus to form an image on a sheet by discharging ink, or a three-dimensional apparatus to discharge a molding liquid to a powder layer in which powder material is formed in layers to form a three-dimensional object.

The liquid discharge apparatus is not limited to an apparatus to discharge liquid to visualize meaningful images, such as letters or figures. For example, the liquid discharge apparatus may be an apparatus that forms meaningless images such as meaningless patterns or an apparatus that fabricates three-dimensional images.

The above-described term recording medium to which liquid can adhere denotes, for example, a material or a medium onto which liquid is adhered at least temporarily, a material or a medium onto which liquid is adhered and fixed, or a material or a medium onto which liquid is adhered and into which the liquid permeates. Examples of the material to which liquid can adhere include sheets of paper, recording media, recording sheets, film, and cloth, electronic components such as electronic boards and piezoelectric elements, and media or medium such as powder layers, organ models, and testing cells. The recording medium onto which liquid can adhere includes any material on which liquid adheres unless particularly limited.

Examples of the above-described material to which liquid is adherable include any materials to which liquid can adhere even temporarily, such as paper, thread, fiber, fabric, leather, metal, plastic, glass, wood, and ceramic.

Further, the term liquid includes any liquid having a viscosity or a surface tension that is dischargeable from the liquid discharge head. However, preferably, the viscosity of the liquid is not greater than 30 mPa·s under ordinary temperature and ordinary pressure or by heating or cooling. More specifically, examples of the liquid include a solution, a suspension, or an emulsion that contains, for example, a solvent, for example, water and an organic solvent, a colorant such as dye and pigment, a functional material such as a polymerizable compound, a resin, and a surfactant, a biocompatible material such as deoxyribonucleic acid (DNA), amino acid, protein, and calcium, or an edible material such as a natural colorant. Such a solution, a suspension, and an emulsion are employed for, for example, inkjet ink, a surface treatment solution, liquid for forming components of an electronic element and a light-emitting element or a resist pattern of an electronic circuit, or a material solution for three-dimensional fabrication.

The liquid discharge apparatus may be an apparatus to relatively move the head and a material on which liquid can adhere. However, the liquid discharge apparatus is not limited to such an apparatus. Examples of the liquid discharge apparatus include a serial-type apparatus which moves the liquid discharge head, and a line-type apparatus which does not move the liquid discharge head.

Examples of the liquid discharge apparatus further include a treatment liquid coating apparatus to discharge a treatment liquid to a sheet to coat the treatment liquid on the surface of the sheet to reform the sheet surface and an injection granulation apparatus in which a composition liquid including raw materials dispersed in a solution is injected through nozzles to granulate fine particles of the raw materials.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A drive circuit comprising:
a first drive-waveform generator circuit to generate a first drive waveform to be applied to piezoelectric elements in a liquid discharge head,
first waveform-selection control circuits, each of which is connected to the first drive-waveform generator circuit, to select the first drive waveform to be applied to the piezoelectric elements in the liquid discharge head;
second drive-waveform generator circuits to generate a second drive waveform to be applied to the piezoelectric elements corresponding to nozzles disposed at each end of the liquid discharge head; and
second waveform-selection control circuits connected in parallel with the second drive-waveform generator circuits, respectively, to select one of the first drive waveform and the second drive waveform to be applied to the piezoelectric element corresponding to the nozzles disposed at each end of the liquid discharge head; and
memory circuits connected to the second drive-waveform generator circuits to store a correction voltage value of the second drive waveform to be applied to the piezoelectric element corresponding to the nozzles disposed at each end of the liquid discharge head.

2. The drive circuit according to claim 1,
a first drive circuit connected to the first drive-waveform generator circuit to drive the piezoelectric elements in the liquid discharge head; and
a second drive circuit connected to the second drive-waveform generator circuits,
wherein the second waveform-selection control circuits select one of the first drive circuit and the second drive circuit to drive the piezoelectric element corresponding to the nozzles disposed at each end of the liquid discharge head.

3. The drive circuit according to claim 1,
wherein the second drive-waveform generator circuits correct a waveform voltage of a drive waveform or an application timing of the drive waveform to increase or decrease a discharge speed of liquid to be discharged from the nozzle at each end of the liquid discharge head.

4. A drive circuit comprising:
a first drive-waveform generator circuit to generate a first drive waveform to be applied to piezoelectric elements in a liquid discharge head,
first waveform-selection control circuits, each of which is connected to the first drive-waveform generator circuits, to select the first drive waveform to be applied to the piezoelectric elements in the liquid discharge head; and
second waveform-selection control circuits respectively connected in parallel with the first drive-waveform generator circuits corresponding to nozzles disposed at each end of the liquid discharge head.

5. A liquid discharge head comprising:
the drive circuit according to claim 1;
the nozzles; and
the piezoelectric elements to be driven by the first drive waveform or the second drive waveform generated by the drive circuit to discharge the liquid from the nozzles.

6. A liquid discharge head comprising:
the drive circuit according to claim 4;
the nozzles; and
the piezoelectric elements to be driven by a drive waveform generated by the drive circuit to discharge the liquid from the nozzles.

7. A liquid discharge device comprising the liquid discharge head according to claim 5.

8. A liquid discharge apparatus comprising the liquid discharge device according to claim 7.

9. An image forming apparatus comprising the liquid discharge apparatus according to claim 8.
